(19) United States
(12) Patent Application Publication
(10) Pub. No.: US 2005/0147730 A1
(43) Pub. Date: Jul. 7, 2005

(54) Method of fortifying seeds with an essential fatty acid, fortified seed and food product

(76) Inventors: Bruce J. Holub, Guelph (CA); Arun Nagpurkar, Mississauga (CA)

Correspondence Address: CALFEE HALTER & GRISWOLD, LLP, 800 SUPERIOR AVENUE, SUITE 1400, CLEVELAND, OH, 44114, US

(21) Appl. No.: 10/752,897

(22) Filed: Jan. 6, 2004

(51) Int. Cl. A23L 1/36

(52) U.S. Cl. 426/629

(57) ABSTRACT

A method is provided for fortifying a seed, grain, nut, bean, or the like with an essential fatty acid such as docosahexaenoic acid or eicosapentaenoic acid. The method comprises dissolving a quantity of the essential fatty acid in a solvent in which the fatty acid is soluble, mixing the solvent containing the essential fatty acid with water and soaking the seed in the mixture so that the essential fatty acid is absorbed into the seed. The seeds may be germinated, dried and ground to a powder, if desired. Using the method, it is possible to produce seeds that can be used as a dietary source of that essential fatty acid. This is advantageous as it allows for the inclusion of an oily substance into a variety of foods without the problems of clumping or phase separation normally associated with the addition of oils to dry foods or aqueous liquids. As well, with the use of algae or plant derived essential fatty acids, it is possible to obtain an easily consumable dietary source of an essential fatty acid that is not animal derived. A seed that has been soaked in an aqueous mixture containing an essential fatty acid so as to become fortified with the fatty acid, and a food product formed using the seed are also provided.

### FIELD OF THE INVENTION

The present invention relates generally to nutrition and fortified foods, and particularly to a method of fortifying a seed with an essential fatty acid, seeds so fortified and food products.

### BACKGROUND OF THE INVENTION

An essential nutrient is a nutrient required by the body for optimal health and functioning that must be obtained from dietary sources due to the fact that the body does not have a metabolic mechanism for synthesis of the nutrient in sufficient quantities to meet body requirements. For example, certain fatty acids, such as omega-3 fatty acids, are considered essential since the body does not possess the enzymes required to produce them in sufficient quantities. As such, they must be obtained from other dietary sources. Most often, such nutrients are found in certain food sources and are ingested.

Essential omega-3 fatty acids, such as alpha-linolenic acid (“ALA”), docosahexaenoic acid (“DHA”) and eicosapentaenoic acid (“EPA”) have been implicated in maintaining cardiovascular and mental health. Particularly, DHA is found in the membranes of heart, blood cells, retinal and neural tissue.

ALA is readily found in certain plant and vegetable sources, such as flax seed, leafy green vegetables and nuts, and is therefore not typically lacking in the diet of most individuals. ALA, even when abundant in the diet, is readily oxidized, potentially resulting in a less effective uptake of ALA by the body than would be expected based on dietary levels of ALA. As well, ALA has no known direct function in the body, aside from acting as a precursor molecule for other polyunsaturated omega-3 fatty acids, such as DHA and EPA (Sinclair and Attar-Bashi Lipids (2002) 37: 1113-1123.).

Although ALA may be converted by the body to DHA or EPA, this conversion requires multiple metabolic steps and occurs at an extremely low efficiency. One study suggests that the conversion of ALA to DHA in adults may be as low as 3.8% on average, based on conversion of deuterated dietary ALA to DHA (E. A. Emken et al., Biochim Biophys Acta (1994) 1213: 277-288). A further study in young adult males detected no conversion of ALA to DHA over a 21 day period (G. C. Burdge et al., Br JNutr (2002) 88: 355-363). As well, subjects fed diets high in ALA did not show an increase in DHA levels, including the levels of DHA in breast milk in lactating women (C. A. Francois et al., Am J Clin Nutr (2003) 77: 226-233). As a consequence, the level of DHA/EPA produced in the body as the result of conversion of dietary ALA may not be sufficient to meet the body requirements.

DHA and EPA are found in marine plants such as algae and in fish, and are most abundant in oily fish. As such, a diet rich in fish or marine plants may provide required quantities of DHA and EPA. Many individuals, however, have diets that are not rich in these foods and therefore may not get an adequate supply of DHA and EPA.

Similarly, infants and young children, for whom proper brain development is critical, may not have an adequate supply of these essential fatty acids in their diet. Although infants that are breast-fed will obtain some ALA, DHA and EPA through breast milk, the levels of DHA in the breast milk is dependent on the mother's dietary intake of this nutrient. Infants fed formula will be dependent on the level DHA and/or EPA in the formula.

Clearly then, there is a need to provide alternate dietary sources of DHA and EPA.

To this end, U.S. Pat. No. 6,436,431 (Hoffpauer et al.) discloses a method of using rice bran as a carrier to produce an admixture that is fortified with various nutrients, including omega-3 fatty acids from fish oil. However, addition of an oily substance to a powder or granular mixture can cause clumping and may result in uneven distribution of the fatty acid throughout the admixture.

Similarly, food supplements and pharmaceutical products containing omega-3 fatty acids have been developed. For example U.S. Pat. No. 6,210,686 (Bell et al.) discloses a yeast fiber-based supplement that may be enriched with omega-3 fatty acids. The supplement may be taken alone or may be added to foods such as beverages, baked goods, puddings, confections, snack foods, or frozen confections or novelties. However, yeast fiber is not a food component normally found in many of these types of foods, and addition of the supplement may alter the taste or consistency of prepared, foods.

EP Patent Application No. 0699437 (Bruzzese) discloses a pharmaceutical composition that includes EPA and DHA formulated into gelatin capsules. Gelatin capsules are not always a convenient method of ingesting these essential fatty acids, particularly for infants, children or for adults that do not like to take medicines or pills.

U.S. Patent Application No. 20020025983 (Horrobin) describes pharmaceutical supplements containing Vitamin K and an essential fatty acid, including EPA or DHA, or a food stuff that has been fortified with Vitamin K and the essential fatty acid. The fatty acid is derived from an oil containing the fatty acid, such as fish oil in the case of DHA and EPA. However, the teaching of this reference does not overcome difficulties associated with addition of an oily substance to foodstuff.

U.S. Pat. No. 5,962,062 (Carrie, et al.) describes a formulated milk product that contains a given ratio of various fatty acids, including DHA and EPA, which are obtained from marine, organisms. However, such products are not suitable for individuals with milk allergies or intolerances, or who prefer not to consume animal byproducts.

Therefore, there remains a need for alternate, easily consumable food sources that allow for the inclusion of an adequate supply of DHA and other essential fatty acids in adult, child and infant diets.

### SUMMARY OF THE INVENTION

In one aspect of the present invention there is provided a method of fortifying seed with an essential fatty acid, comprising: dissolving a quantity of the essential fatty acid in a solvent; mixing the solvent containing the essential fatty acid with water to form a mixture; and soaking the seed in the mixture so that an amount of the essential fatty acid is absorbed into the seed.

In another aspect of the present invention, there is provided a method of fortifying rice grain with an essential fatty acid selected from the group consisting of docosahexaenoic acid and eicosjapentaenoic acid. The method includes dissolving a quantity of the essential fatty acid in a solvent; mixing the solvent containing the essential fatty acid with water in a ratio of between about 5:95 and about 20:80 of solvent containing the essential fatty acid:water to form a mixture, the quantity of the essential fatty acid being sufficient to provide a final concentration in the mixture of between about 0.5% and 3%; soaking the rice grain in the mixture so that an amount of the essential fatty acid is absorbed into the rice grain.

In yet another aspect, of the present invention, there is provided a method of fortifying plant matter with an essential fatty acid, comprising: dissolving a quantity of the essential fatty acid in a solvent; mixing the solvent containing the essential fatty acid with water to form a mixture; soaking the plant matter in the mixture so that an amount of the essential fatty acid is absorbed into the plant matter.

In a further aspect of the present invention, there is provided a seed that is fortified with an essential fatty acid.

In still a further aspect of the present invention, there is provided plant matter that is fortified with an essential fatty acid, wherein the plant matter is fortified by soaking the seed in a mixture containing the essential fatty acid, the mixture comprising a solvent and water, the solvent containing the essential fatty acid.

In yet a further aspect of the present invention, there is provided a food product for human consumption, formed at least in part using a seed that is fortified with an essential fatty acid.

In yet another aspect of the present invention, there is provided a food product for human consumption; formed at least in part using seed that is fortified with an essential fatty acid, wherein the seed is fortified by soaking the seed in a mixture containing the essential fatty acid.

In still yet another aspect of the present invention, there is provided a food product for human consumption formed at least in part using plant matter that is fortified with an essential fatty acid, wherein the plant matter is fortified by soaking the seed in a mixture containing the essential fatty acid, the mixture comprising a solvent and water, the solvent containing the essential fatty acid.

Therefore, in accordance with an aspect of the present invention an essential fatty acid is incorporated into a seed by soaking the seed in a solvent/water mixture containing the fatty acid. This allows for the introduction or the augmentation of natural levels of a particular fatty acid in the seed.

Generally, seeds will absorb aqueous solutions and components carried within those solutions via a passive transport mechanism. However, fatty acids, because of their long hydrophobic hydrocarbon chains, are not soluble in water, making such a mechanism for the fortification of a seed with an essential fatty acid a difficult process.

The inventors have found that by first solubilizing an essential fatty acid in an organic solvent and then mixing or dispersing the dissolved fatty acid in solvent into water, a water based mixture of the fatty acid can be formed that is useful for soaking seeds that are to be fortified with the chosen fatty acid.

This method is particularly useful for providing EPA/DHA enriched foods source that are not normally associated with these fatty acids, for example, rice, corn and soya. These foods can be easily consumed and are rich in the essential fatty acids DHA and EPA, which are most commonly found in fatty fish. The food source may not ordinarily contain DHA or EPA. Preferably the essential acid is plant-derived. When this is the case, the resulting seed may appeal to a wide population, including vegetarians.

The present invention also provides a plant-based food component including an essential fatty acid that may be ground into a fine powder. Advantageously, this allows for the inclusion of an oily substance into a variety of food products without the problems of clumping or phase separation normally associated with the addition of oils to dry foods or aqueous liquids.

Other aspects and features of the present invention will become apparent to those of ordinary skill in the art, upon review of the following description of specific embodiments of the invention and in conjunction with the accompanying figures.

### BRIEF DESCRIPTION OF THE DRAWINGS

In the figures, which, illustrate, by way of example only, embodiments of the present invention:

FIG. 1 is a process flow diagram, illustrating a method of fortifying a seed with an essential fatty acid, exemplary of an embodiment of the present invention;

FIGS. 2A-2B are graphs illustrating the results of experiments incorporating fish oil containing] DHA and EPA into fenugreek seeds which were germinated after washing;

FIGS. 3A-3B are graphs illustrating the results of experiments incorporating free DHA into fenugreek seeds which were germinated after washing;

FIGS. 4A-4B are graphs illustrating the results of experiments incorporating fish oil and free DHA into flax seeds using varying ethanol concentrations; and

FIGS. 5A-5B are graphs illustrating the results of experiments incorporating free DHA into basmati rice grains.

### DETAILED DESCRIPTION

As used herein, the term “essential fatty acid” shall mean a nutrient required by a human that cannot be synthesized at all or by human metabolism in sufficient quantities required for optimal health, and must be obtained from dietary sources.

The term “seed” shall mean a mature ovule of a flowering plant or any portion thereof. Therefore, the term “seed” shall include the edible kernel, endosperm, germ, bran or husk of a seed, grain, bean, legume or nut. For example, the term shall include white rice, which is the endosperm of the rice seed, and shall also include rice bran. The seed should be a human food source.

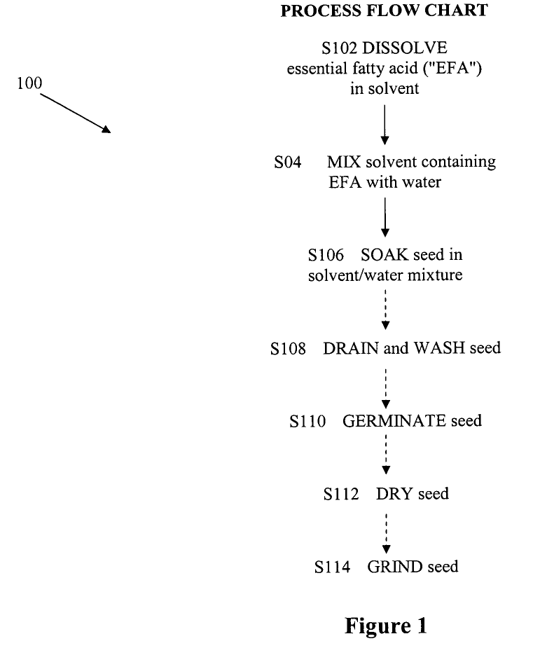

FIG. 1 is a schematic representation of a method 100 of fortifying seed with an essential fatty acid. As illustrated, in step S102 a quantity of the essential fatty acid is dissolved in a solvent. Example essential fatty acids include but are not limited to, omega-3 fatty acids such as ALA, DHA, and EPA.

The essential fatty acid may already occur naturally within the seed that is to have the essential fatty acid incorporated. As a consequence, the natural levels of the essential fatty acid within that seed may be augmented by method 100. Alternatively, the essential fatty acid may be one that does not exist in the seed, whereby method 100 will result in the introduction of a novel fatty acid into the seed. As such, the term “fortifying” as used herein refers to the process of either increasing the levels of an essential fatty acid that is normally found in a seed to levels above the natural levels of that fatty acid in the seed, or of introducing a fatty acid not normally found within the seed to that seed. Similarly “fortified” describes a seed in which the levels of an essential fatty acid have been increased above the natural levels of that fatty acid normally found in the seed, or to which a fatty acid previously not found in the seed has been added.

The quantity of essential fatty acid may be in the form of a free fatty acid, in which the acid moiety of the fatty acid is not directly covalently bonded to a backbone molecule of a fat. Alternatively, the quantity of essential fatty acid may be incorporated into a fat or oil, for, example by esterification of the acid group with a hydroxy group of a backbone molecule of the fat, such as the glycerol moiety of a triacylglycerol. In a preferred embodiment, the quantity of essential fatty acid used in method 100 is docosahexaenoic acid or eicosapentaenoic acid. The essential fatty acid may for example be docosahexaenoic acid obtained from an algal source. The essential fatty acid may be obtained from an organism genetically engineered to produce the particular fatty acid. Such a genetically engineered organism may be one that does not normally produce the essential fatty acid, or it may be one that normally produces the essential fatty acid at low levels, but has been genetically modified to produce higher levels of the essential fatty acid.

The quantity of essential fatty acid is dissolved in the solvent either by addition of the solvent to the essential fatty acid, or by addition of the essential fatty acid to the solvent.

The solvent may be any solvent in which the essential fatty acid is soluble. Since fatty acids in general are not soluble in water or aqueous solution, the solvent will preferably be an organic solvent. As well, the solvent is preferably suitable for ingestion by a human. The solvent itself may or may not be miscible with water. In one embodiment, the solvent is ethanol. In one embodiment an emulsifier is used in addition to the solvent. In another embodiment the solvent is an emulsifier. Preferably, the emulsifier is also suitable for ingestion by a human. In one embodiment the emulsifier is lyso-lecithin or lecithin. In another embodiment the emulsifier is a detergent, for example, Triton X-100™.

The concentration of the essential fatty acid in the solvent will vary, depending on the solubility of the essential fatty acid in the particular solvent, the ratio of solvent to water that is to be used, the nature of the particular seed to be in which the essential fatty acid is to be incorporated and the desired end concentration of the essential fatty acid into the particular seed. The desired end concentration of essential fatty acid will be determined in part by the effect of addition of the essential fatty acid on the flavor of the resulting fortified seed. In one embodiment, the end concentration of essential fatty acid is between about 1 and 15 mg of DHA and/or EPA per g of powdered seed.

An appropriate ratio for a given essential fatty acid/solvent/seed combination can be readily determined by a skilled person using minimal routine experimentation. In one embodiment, the concentration of the essential fatty acid in free form or of an esterified fat containing the essential fatty acid in the final solvent/fatty acid/water mixture is between about 0.5 and about 5%. In another embodiment the concentration is between about 0.5 and about 3%.

Once the quantity of essential fatty acid is dissolved in the solvent, the solvent, now containing the essential fatty acid, is mixed with water so as to form a mixture in step S102. Since the essential fatty acid is not soluble in water, the solvent with dissolved essential fatty acid will become dispersed in the water so as to form an emulsion, rather than dissolve in the water to form a single phase solution. Preferably, the solvent containing essential fatty acid is added to water with vigorous mixing, such as by sonicating or vortexing the mixture to create an emulsion with fine droplet size. The solvent containing the essential fatty acid may be added in a dropwise manner while the waiter is vigorously mixed. The resulting mixture may be mixed for a period of time after addition of the solvent containing the essential fatty acid so as to ensure complete dispersion of the solvent and dissolved essential fatty acid in the water.

The ratio of solvent containing the essential fatty acid to water may vary. The water content should be high enough to properly effect the absorption of the fatty acid into the seed. Too high a concentration of organic solvent may disrupt the integrity of the seed. Preferably, the ratio is between 1:99 and 50:50, more preferably between 5:95 and 20:80.

In step S106, seed is soaked in the mixture such that the seed absorbs some of the essential fatty acid so as' to become fortified with the essential fatty acid. The seed may be whole intact seed, or it may be processed before soaking so as to break up the whole seed into fragments. In various embodiments of the method, the seed may be flax, fenugreek, chick pea, kidney bean, soya bean, white rice, brown rice, wild rice, wheat, corn, barley, hemp, canola, millet, spelt, amaranth, wheat germ, wheat bran, rice bran or cumin;

Enough solvent/essential fatty acid/water mixture should be used to properly cover the seed, such that all the seeds will be properly exposed to the essential fatty acid. In one embodiment, the volume ratio of seeds to solvent/essential fatty acid/water mixture is between about 1:1 and about 1:6.

The seed may be soaked for a period of time long enough to effect the absorption of an appropriate amount of the essential fatty acid into the seed. Soaking time will vary depending on the seed, the concentration of essential fatty acid in the solvent/water mixture, and the desired concentration of essential fatty acid to be absorbed into the seed. Soaking time can readily be determined by a skilled person with minimal exercise of routine experimentation. In various embodiments, soaking time may be between 1 and 24 hours, or between 3 and 18 hours. The level of essential fatty acid that has been incorporated into the seed as a result of steps S102-S106 may be determined by standard methods known in the art, for example, by gas chromatography, liquid chromatography, capillary chromatography or gas-liquid chromatography.

Soaking should be done under conditions that are conducive to maintaining the integrity of the seed and the fatty acid. For example, certain polyunsaturated fatty acids are extremely sensitive to light, oxygen and/or high temperature. Thus, for essential fatty acids that are light and oxygen sensitive, soaking should be done in the absence of light under reduced oxygen conditions at room temperature. Care should be exercised to ensure that the seed is not soaked long enough to leach other nutrients' into the solvent/water mixture. Similarly, the seed should not be soaked long enough to loose its physical properties (e.g. texture and consistency).

In step S108, the solvent/water mixture is drained and the seed is washed after soaking is complete. Washing removes excess solvent, minimizing the intake of the solvent by the individual that is to consume the seed. Washing also removes excess fatty acid. Multiple rounds of washing using clean water may be done to ensure complete removal of the excess mixture. However, in some instances, more essential fatty acid may be absorbed by the seed without washing, and therefore it may be desirable to eliminate the washing step.

Optionally, the seed may be germinated in step S110 prior to drying. Germination time will depend on the particular seed, fatty acid source and germination conditions used. Under some conditions, germination may maximize the amount of essential fatty acid taken up into the seed. In one embodiment, the seeds are germinated for between 1 and 7 days, more preferably between 1 and 3 days, more preferably between 12 and 72 hours.

Once the seed has been soaked and optionally drained and washed, the seed may optionally be dried in, step S112 so as to prevent mildewing of the seed. Drying may be achieved by standard methods known in the art, using for example low to moderate heat or by freeze-drying. If drying is done with heat, a dessicant may be used. Drying may also be done, with circulating air.

Once the seed, or the germinated seed, has been dried, it may be ground into a powder if desired in step S114. Grinding may be done using conventional methods that are known to a person skilled in the art.

Advantageously, method 100 results in whole seed or powdered seed fortified with an essential fatty’ acid. Such seed or powder may be consumed directly or incorporated as a conventional ingredient into other food products for human consumption, providing a convenient increased dietary supply of the essential fatty acid. For example, flax that is fortified with DHA may be consumed directly or added as a topping to cereal or salad. As well, flax fortified with DHA may be ground to a powder and used in baked products, such as bread, or it may be added to products such as infant formula or meal replacement drinks and bars.

For example, bread may be baked with 2.5% to 10% (w/w) of fortified ground flax that has been fortified with approximately 3.5 mg of DHA per g of powdered flax. A resulting 25 g slice of bread contains between about 2.2 and 8.8 mg of DHA. Similarly, a 20 g cookie may be made with 25% (w/w) flax powder containing approximately 3 mg of DHA plus EPA per g of flax powder contains approximately 15 mg of combined DHA and EPA.

For example, bread fortified with EPA and DHA may be prepared according to the following recipe:

Ingredients

| | | | |
|---|---|---|---|
| unbleached flour | 9080 g | starter with yeast | 454 g |
| purified water | 3178 ml | honey | 227 g |
| BrainEEO ™ flax powder | 227 g | salt | 84 g |
| olive oil | 200 g | | |

Directions
Blend flour and water to form a dough mixture; add remaining ingrdients to dough mixture; prepare dough for baking as required, including kneading, shaping and proofing; bake at 450° F.; makes 16 loaves.

Similarly, cookies may be prepared, for example, by adding 100 g of BrainEEO™ flax powder to 450 g of commercially available cookie mix and then preparing the mix in accordance with the instructions.

The above description is given in terms of fortifying a seed. However, it will be apparent that the above description may be readily adapted to apply to plant matter, such plant matter being any portion or part of a plant whether intact or processed into fragments. For example, the above method can be used to fortify roots, tubers, or the rhizome of a plant with an essential fatty acid. In one embodiment, turmeric may be (fortified with EPA and DHA, turmeric being powder derived from the rhizome of the plant Curcuma domestica.

The following experiments are illustrative of performing method 100 and resulting fortified seed, and do not limit the broad aspects of the method or seed as disclosed herein.

### EXAMPLES

Generally, the experiments were performed as follows: Solutions were prepared with either fish oil (containing 35% EPA and 30% DHA or 0% EPA and 45% DHA) or with free fatty acid DHA (derived from the algae Crypthecodinium cohnii), as specified.

Conveniently, the use of algal- or plant-derived essential fatty acids allows an easily consumable dietary source of an essential fatty acid that is not animal derived to be created.

Solutions were prepared by adding quantities of the example essential fatty acid, either alone or in ethanol, dropwise to water while vortexing. Solutions were then vortexed for an additional 10 to 15 minutes. The final concentration of fish oil or free fatty acid in the water solution was between 0 and 3% (w/v) as indicated. The final concentration of ethanol in the water solution was between 0 and 100 (no water) % (v/v) as indicated. Seeds used were fenugreek, flax and rice (either a commercial brand of converted rice or basmati rice). Seeds were soaked for between 0.5 and 24 hours in a ratio of between 1:1 to 1:6 of seed: solution volume, as specified. Mixing and soaking were done at a temperature between 22° C. and 32° C. In some instances, seeds were then washed 5 to 10 times with clean water and drained. Seeds were in some cases germinated in a humid environment for between 0 and 168 hours. Seeds were then dried to a final moisture content of 5% as determined by gravimetric analysis and in some cases ground to powder using a grinder that does not generate excessive heat. Drying was done at low temperature, 30° C. to 40° C., and under air flow. Levels of EPA, DHA, linoleic acid (“LA”), alpha linolenic acid (“ALA”) in the seeds were determined by gas chromatography methods. Levels of DHA and EPA as a percentage of total fatty acids in the seed were also determined. The results of some individual experiments are set cut in the following examples, with accompanying tables and figures.

Fenugreek with Fish Oil

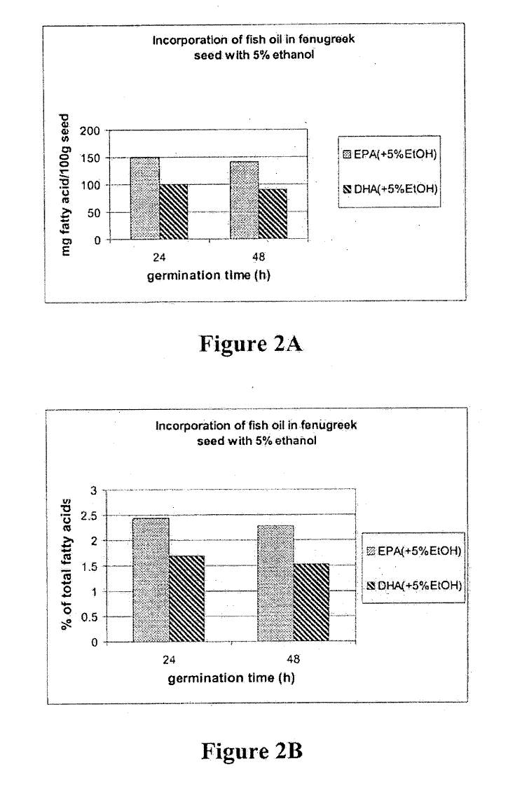

As shown in Table 1, and FIGS. 2A-2B, experiments were done on 100 g fenugreek in a total volume of 200 ml; using fish oil containing 35% EPA and 30% DHA. Soaking time was 24 hours, and the seed to mixture volume ratio was 1:2. The concentration of ethanol was 5% (v/v) and germination time was between 24 and 48 hours. The final concentration pf fish oil in the soak mixture was 1% (w/v). After soaking and germinating, seeds were then dried and ground.

The results for EPA and DHA uptake in fenugreek that was germinated for 24 or 48 hours, dried and ground, are depicted in FIGS. 2A-2B, either as total mass of EPA or DHA per 100 g of seeds (FIG. 2A) or as a mass percentage of the total fatty acid content of the seeds (FIG. 2B). The efficiency of incorporation of EPA and DHA using 5% ethanol was 19% after 24 hours germination. Final levels of EPA and DHA were slightly higher with less germination time (compare 24 hrs versus 48 hours).

TABLE 1
Fenugreek Fortified VsinaFish Oil With 5% Ethanol

| | | |
|---|---|---|
| concentration ethanol (% v/v) | 5 | 5 |
| seed mass (g) | 100 | 100 |
| total volume (ml) | 200 | 200 |
| concentration fish oil (% w/v) | 1 | 1 |
| seed mass:water volume | 1:2 | 1:2 |
| soak time (h) | 24 | 24 |
| germination time (h) | 24 | 48 |
| LA (mg/100 g seed) | 2490 | 2520 |
| ALA (mg/100 g seed) | 1200 | 1220 |
| EPA (mg/100 g seed) | 150 | 140 |
| DHA (mg/100 g seed) | 100 | 90 |
| efficiency of incorporation (%) | 19 | |
| EPA + DHA at 24 h | | |

Fenugreek With Free DHA

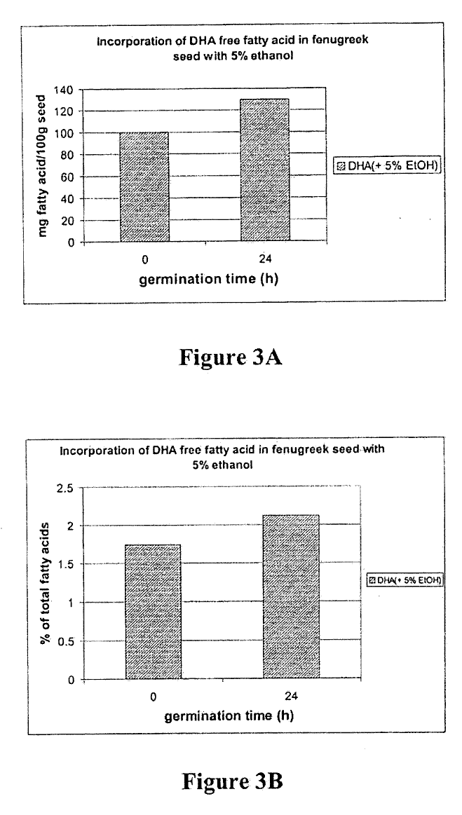

As set out in Table 2 and FIGS. 3A-3B, fenugreek was soaked in a solution containing 0.5% or 0.55% DHA free fatty acid, with 5% ethanol in the final soak mixture. Soak time was 24 hours, using a seed:mixture volume ratio of 1:2.6 or 1:2.25. Seeds were germinated either 0 or 24 hours after washing and then dried and ground. The results of DHA add EPA uptake in the final fenugreek powder, as measured in mg/100 g of seeds and as a percentage of total fatty acid are set out in Table 2 and FIGS. 3A-3B.

It was observed that, dissolving the free fatty acid in ethanol prior to forming the soak mixture resulted in 11% efficiency of incorporation after 24 hours germination. As well, germinating for 24 hours increased the amount of DHA taken up by the seeds.

TABLE 2
Fenugreek Fortified Using Free DHA, With 5% Ethanol

| | | |
|---|---|---|
| concentration ethanol (% v/v) | 5 | 5 |
| seed mass (g) | 50 | 50 |
| total volume (ml) | 125 | 125 |
| concentration DHA (% w/v) | 0.5 | 0.5 |
| seed mass:water volume | 1:2.25 | 1:2.25 |
| soak time (h) | 24 | 24 |
| germination time (h) | 0 | 24 |
| LA (mg/100 g seed) | 2640 | 2760 |
| ALA (mg/100 g seed) | 1230 | 1280 |
| DHA (mg/100 g seed) | 100 | 130 |
| efficiency of incorporation (%) | 11 | |
| EPA + DHA at 24 h | | |

Flax With Free DHA or Fish Oil

25 g of flax seed (Table 3) was soaked 12 hours in a mixture containing either fish oil containing 35% SPA and 30% DHA, or DHA free fatty acid, and between 5 and 17% ethanol (v/v). The seed:mixture ratio was 1:3.2, 1:3.6 and 1:3 for fish oil with 6% ethanol, fish oil with 17% ethanol and free DHA with 5% ethanol, respectively. The final concentration of fish oil was either 2.5 or 2.2% and the final concentration of DHA free fatty acid was 0.6% (w/v) in the soak mixture.

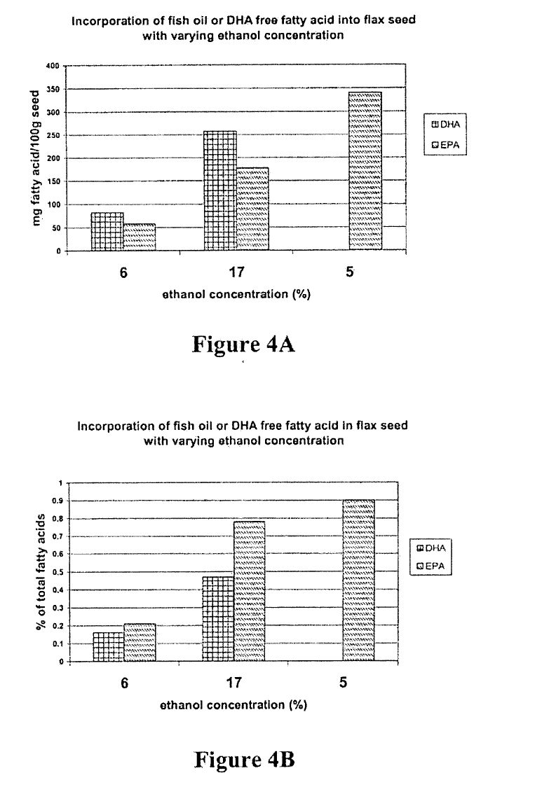

Higher levels of ethanol were found to increase the incorporation efficiency of DHA into the flax seeds (compare fish oil, 6% and 17% ethanol). It was also found that the free fatty acid was incorporated more efficiently than the fish oil, as illustrated in FIG. 4.

TABLE 3
Flax Seed Fortified Using Fish Oil or DHA Free Fatty Acid

| | | | |
|---|---|---|---|
| concentration ethanol (% v/v) | 6 | 17 | 5 |
| seed mass (g) | 25 | 25 | 25 |
| total volume (ml) | 80 | 90 | 75 |
| concentration fish oil (% w/v) | 2.5 | 2.2 | — |
| concentration DHA (% w/v) | — | — | 0.6 |
| seed mass:water volume | 1:3.2 | 1:3.6 | 1:3 |
| soak time (h) | 13 | 12 | 14 |
| LA (mg/100 g seed) | 5845 | 5577 | 5910 |
| ALA (mg/100 g seed) | 21587 | 20565 | 21860 |
| EPA (mg/100 g seed) | 82 | 257 | — |
| DHA (mg/100 g seed) | 58 | 177 | 340 |
| efficiency of incorporation (%) | 2.6 | 12 | 18 |
| EPA + DHA | | | |

Fice With Free DHA

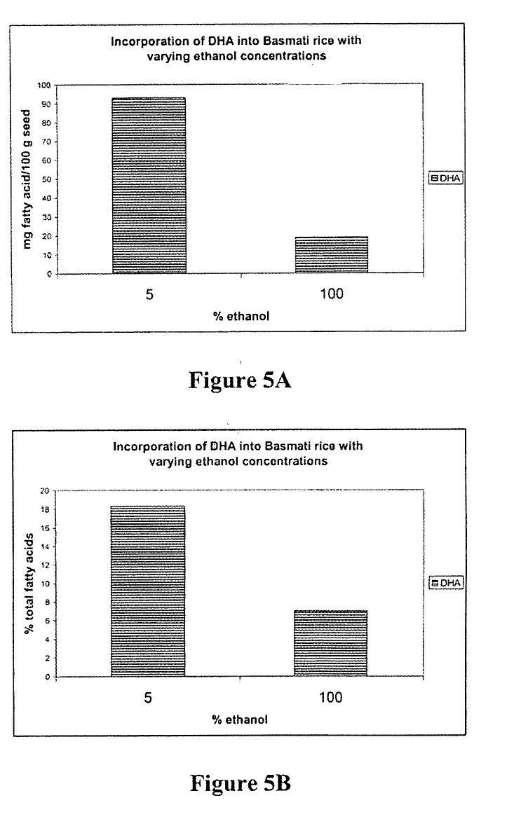

Similar experiments were done using basmati rice fortified with DHA free fatty acid (Table 4, FIGS. 5A-˜B). Prior to fortification, the basmati rice was soaked in the mixture for either 6 or 11 hours using a 1:1.5 seed:mixture ratio. 5 or 100 ethanol was used in the mixture, with 0.6% (w/v) free DHA. Rice was washed and dried following soaking before fatty acid content was determined.

Greater incorporation of the free fatty acid was observed when the ethanol concentration was 5%, as compared to 100% (FIGS. 5A-5B). Efficiency of incorporation was 9.4% and 2% for 5 and 100% ethanol, respectively.

TABLE 4
Fortification of Basmati Rice Using Free DHA

| | | |
|---|---|---|
| concentration ethanol (% v/v) | 5 | 100 |
| seed mass (g) | 100 | 50 |
| total volume (ml) | 150 | 75 |
| concentration DHA (% w/v) | 0.6 | 0.6 |
| seed mass:water volume | 1:1.5 | 1:1.5 |
| soak time (h) | 11 | 6 |
| LA (mg/100 g seed) | 186 | 109 |
| ALA (mg/100 g seed) | 16 | 4 |
| DHA (mg/100 g seed) | 94 | 18 |
| efficiency of incorporation | 9.4 | 2 |
| EPA + DHA at 24 h | | |

Preparation of Baked Goods Using Fortified Flax

Table 5 sets out projected levels of ALA and DHA or EPA and DHA that would be incorporated into bread baked with flax fortified either with free DHA or with fish oil containing EPA and DHA, or into cookies made with flax powder fortified either with DHA or with fish oil containing EPA and DHA.

TABLE 5
Projected levels of Fortified Fatty Acids in
Goods Baked with Fortified Flax

| | projected levels (mg) | | |
|---|---|---|---|
| | ALA | DHA | EPA + DHA |
| slice of bread 25 g | | | |
| 2.5% (w/w) flax fortified with fish oil | 141 | 2.2 | — |
| 2.5% (w/w) flax fortified with free DHA | 132 | — | 3 |
| 10% (w/w) flax fortified with fish oil | 560 | 8.8 | — |
| 10% (w/w) flax fortified with free DHA | 528 | — | 12 |
| cookie 20 g | | | |
| 25% (w/w) flax fortified with fish oil | 397 | 6.2 | — |
| 25% (w/w) flax fortified with free DHA | 400 | — | 15.2 |

All technical and scientific terms used herein have the same meaning as commonly understood by one of ordinary skill in the art of this invention, unless defined otherwise. Although various embodiments of the present method and seed are disclosed herein, many adaptations and modifications may be made within the scope of the method and seed in accordance with the knowledge of those skilled in this art.

1. A method of fortifying seed with an essential fatty acid, comprising: dissolving a quantity of said essential fatty acid in a solvent; mixing said solvent containing said essential fatty acid with water to form a mixture; soaking said seed in said mixture so that an amount of said essential fatty acid is absorbed into said seed.

2. The method of claim 1 wherein said essential fatty acid is an omega-3 fatty acid.

3. The method of claim 2 wherein said essential fatty acid is selected from the group consisting of docosahexaenoic acid and eicosapentaenoic acid.

4. The method of claim 3 wherein said seed is selected from the group consisting of flax seed, fenugreek and rice.

5. The method of claim 4 wherein said solvent is an organic solvent.

6. The method of claim 5 wherein said solvent is ethanol.

7. The method of claim 6 wherein said mixing comprises mixing said solvent containing said essential fatty acid and water in a ratio of between about 5:95 and about 20:80 of solvent containing said essential fatty acid:water.

8. The method of claim 7 wherein said mixture has a concentration of said essential fatty acid of between about 0.5% and about 3%.

9. The method of claim 6 wherein said soaking is performed for between 1 and 24 hours.

10. The method of claim 9 wherein said soaking is performed in a volume of said mixture that is between two and five times the volume of said seed.

11. The method of claim 1 further comprising draining and washing said seed after said soaking.

12. The method of claim 11 further comprising drying said seed after said washing.

13. The method of claim 12 further comprising grinding said seed.

14. The method of claim 13 further comprising germinating said seed prior to said drying.

15. The method of claim 14 wherein said germinating is performed for between 12 and 72 hours.

16. The method of claim 1 wherein said solvent is an emulsifier.

17. The method of claim 1 further comprising adding an emulsifier.

18. The method of claim 17 wherein said emulsifier is selected from the group consisting of lyso-lecithin, lecithin and Triton X-100.

19. A method of fortifying rice grain with an essential fatty acid selected from the group consisting of docosahexaenoic acid and eicosapentaenoic acid, comprising: dissolving a quantity of said essential fatty acid in a solvent; mixing said solvent containing said essential fatty acid with water in a ratio of between about 5:95 and about 20:80 of solvent containing said essential fatty acid:water to form a mixture, said quantity of said essential fatty acid being sufficient to provide a final concentration in said mixture of between about 0.5% and 3%; soaking said rice grain in said mixture so that an amount of said essential fatty acid is absorbed into said rice grain.

20. A method of fortifying: plant matter with an essential fatty acid, comprising: dissolving a quantity of said essential fatty acid in a solvent; mixing said solvent containing said essential fatty acid with water to form a mixture; soaking said plant matter in said mixture so that an amount of said essential fatty acid is absorbed into said plant matter.

21. The method of claim 20, wherein said plant matter is selected from the group consisting of root, tuber and rhizome.

22. The method of claim 21, wherein said plant matter is turmeric.

23. A seed that is fortified with an essential fatty acid.

24. The seed of claim 23, wherein said essential fatty acid is an omega-3 fatty acid.

25. The seed of claim 24, wherein said essential fatty acid is selected from the group consisting of docosahexaenoic acid and eicosapentaenoic acid.

26. The seed of claim 25 wherein said seed is selected from the group consisting of flax seed, fenugreek and rice.

27. The seed of claim 26 that is dried.

28. The seed of claim 27 that is powdered.

29. The seed of claim 28 that has been germinated.

30. The seed of claim 23, wherein said seed is fortified by soaking said seed in a mixture containing said essential fatty acid.

31. The seed of claim 30, wherein said mixture comprises a solvent and water, said solvent containing said essential fatty acid.

32. The seed of claim 31, wherein said solvent is ethanol.

33. The seed of claim 31, wherein said mixture further comprises an emulsifier.

34. The seed of claim 31, wherein said solvent is an emulsifier.

35. The seed of claim 33, Wherein said emulsifier is selected from the group consisting of lyso-lecithin, lecithin and Triton X-100™.

36. The seed of claim 31, wherein said mixture comprises said solvent containing said essential fatty acid and water in a ratio of between about 5:95 and about 20:80 of solvent containing said essential fatty acid:water.

37. The seed of claim 36, wherein said mixture has a concentration of said essential fatty acid of between about 1% and about 3%.

38. Plant matter that is fortified with an essential fatty acid, wherein said plant matter is fortified by soaking said seed in a mixture containing said essential fatty acid, said mixture comprising: a solvent and water, said solvent containing said essential fatty acid.

39. The plant matter of claim 38, wherein said plant matter is selected from the group consisting of root, tuber or rhizome.

40. The plant matter of claim 38, wherein said mixture further comprises an emulsifier.

41. The plant matter of claim 38, wherein said solvent is an emulsifier.

42. A food product for human consumption, formed at least in part using a seed that is fortified with an essential fatty acid.

43. The food product of claim 43, wherein said seed is between about 2.5% and about 25% (w/w) of said food product.

44. The food product of claim 43, wherein said essential fatty acid is selected from the group consisting of docosahexaenoic acid and eicosapentaenoic acid.

45. The food product of claim 44, wherein said seed is flax seed.

46. The food product of claim 45, wherein said seed is powdered.

47. The food product of claim 46 that is bread, wherein said seed is between about 2.5% and about 10% (w/w) of said food product.

48. The food product of claim 46 that is a cookie, wherein said seed is between about 20% and about 25% (w/w) of said food product.

49. A food product for human consumption, formed at least in part using the seed of claim 30.

50. A food product for human consumption, formed at least in part using the plant matter of claim 38.
